(19) United States
(12) Patent Application Publication
(10) Pub. No.: US 2016/0346850 A1
(43) Pub. Date: Dec. 1, 2016

(54) TABLE SAW EXTENSION

(71) Applicant: William L. Cox, Port St. Lucie, FL (US)

(72) Inventor: William L. Cox, Port St. Lucie, FL (US)

(21) Appl. No.: 15/164,416

(22) Filed: May 25, 2016

Related U.S. Application Data
(60) Provisional application No. 62/167,479, filed on May 28, 2015.

(51) Int. Cl. B23D 47/02; B23Q 3/10; B23Q 1/74

(52) U.S. Cl. CPC B23D 47/025; B23Q 1/74; B23Q 3/105

(57) ABSTRACT

Disclosed is an extension platform for securement to a conventional table saw that allows for the accurate cutting of larger workpieces. The extension platform is formed from a support wall with a resistant free, height adjustable, material rest to allow movement of an oversize workpiece without marring the workpiece. The extension platform is secured to the table saw by a rail that fits through a guide mounted on the table saw and used for support of an alignment fence. The support platform can be stored adjacent to the table saw without interfering with the table saw operation and easily deployable by use of casters wherein an extension rail can be locked to the guide to prevent movement of the extension platform.

The application is based upon and claims the priority date of U.S. Provisional Patent 62/167,479 filed May 28, 2015 entitled TABLE SAW EXTENSION, the contents of which is fully incorporated herein.

### FIELD OF THE INVENTION

This invention is directed to the field of table saws and in particular to a table saw extension for supporting large workpieces that are to be cut by the table saw.

### BACKGROUND OF THE INVENTION

Cabinet style table saws are known to be heavy, using large amounts of steel or other heavy metals in order to minimize vibration which increase the accuracy of the saw action. A conventional cabinet table saw includes a base housing an electric motor for rotating a circular saw blade. A typical circular saw blade is about ten inches in diameter wherein a portion of the blade is positioned above an upper surface of the table, wherein a workpiece such as panel wood, is drawn across the circular blade. The distance the saw blade extends above the upper surface of the table is adjustable to meet the thickness of the workpiece allowing the circular blade to cut the wood at an optimum angle. The distance from an edge of the workpiece to the saw blade is adjustable by use of a planar alignment bracket, commonly called a fence.

The table saw allows precision cutting of large objects where an edge of an object is drawn against a fence so as to maintain the distance of the workpiece from the cutting blade as the workpiece is being drawn across the table. The result is a workpiece having a uniform edge from by the cutting action across the length or width of the workpiece.

A problem with cabinet style table saws is when they are used on oversize workpieces. For instance, a 4′×8′ sheet of panel wood may need to be cut to fit a particular project. An individual may be drawn in to assist in the cutting activity by holding up the outer edge of the workpiece as it is being drawn through the saw blade. However, use of an individual adds an additional element as the individual holding the workpiece may slightly lift or depress the workpiece wherein the cutting blade will cause angular cuts that are inappropriate for the project needing a uniform cut. While the angular cut may not be noticeable by the untrained eye, an angular cut results in a breach to the project that can cause improper fit and finish. This is especially critical when forming items such as furniture where edge gaps would make the device most unsightly.

Thus, what is lacking in the art is a table saw extension that can be easily attached to a conventional table saw. The extension of the instant invention allows for ease of attachment but provides a friction free support platform at an adjustable distance from the table top to allow proper support of a workpiece when drawn across a saw blade.

### BRIEF SUMMARY OF THE INVENTION

Disclosed is an extension platform for use with a conventional table saw. The extension platform consists of a support wall that is movable in respect to the table saw by use of casters, with an adjustable extension rail extending between a support wall and A table saw guide sleeve. An upper portion of the extension platform includes a material rest, having a friction-free and non-marring surface so as to allow a distal end of a workpiece to be drawn across the extension platform to permit proper cutting with repeatable accuracy. The base of the support wall and the material rest include adjustments so as to provide level support of the workpiece.

An objective of the instant invention is to provide an extension platform to improve the accuracy of cutting large pieces using a conventional table saw.

Another objective of the invention is to provide an extension platform that can be attached to a conventional table saw and readily moved from a storage position to a deployed position without modification to the table saw.

Yet another objective of the invention is to provide an extension platform that can be adjusted in height so as to provide a level cutting surface to accommodate floor inaccuracies.

Yet another objective of the invention is to provide an extension platform having an adjustable material rest that is covered with a friction-free surface allowing an individual to make the necessary cuts on a larger workpiece without assistance.

Yet still another objective of the invention is to provide an extension platform that allows table saw operation by a single individual and provide more accurate cuts then possible with multiple people are employed to hold the work piece.

Other objectives and further advantages and benefits associated with this invention will be apparent to those skilled in the art from the description, examples and claims which follow.

### BRIEF DESCRIPTION OF THE DRAWINGS

FIG. 1 is a perspective view of the extension table with a table saw;

FIG. 2 is a cross-sectional view of a support wall having adjustable heights;

FIG. 3 a side view of an L-bracket support for mounting a support wall to an aluminum rail;

FIG. 4 is a left side pictorial view of a table saw with the extension table is a stored position;

FIG. 5 is a right side pictorial view of a table saw with the extension table is a stored position;

FIG. 6 is a left side pictorial view of a table saw with the extension table is a deployed position; and

FIG. 7 is a right side pictorial view of a table saw with the extension table is a deployed position.

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure.

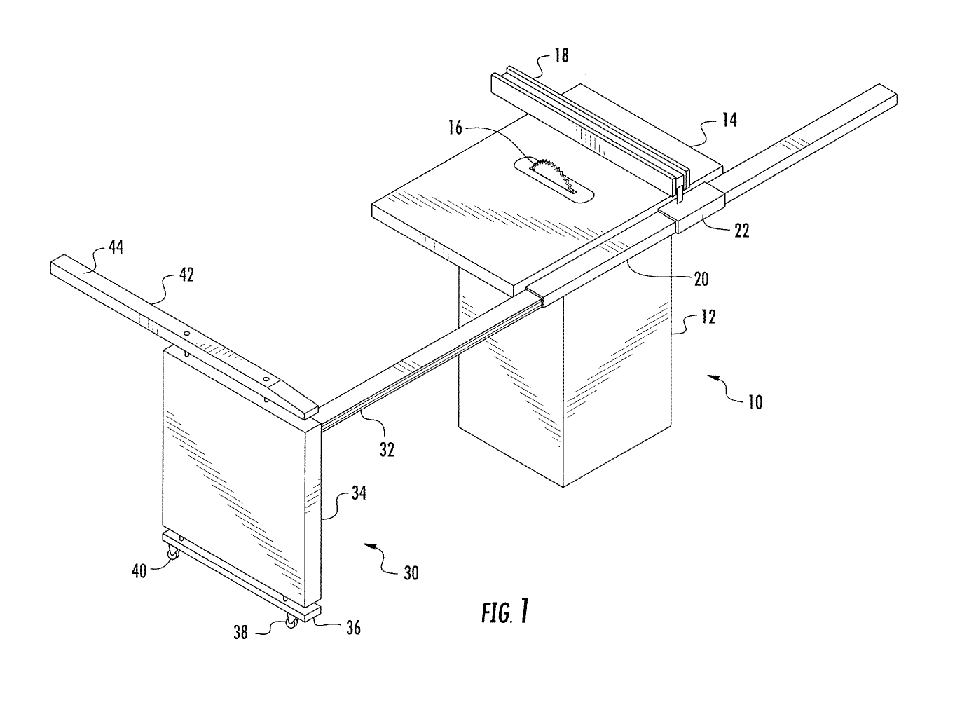

Referring now to FIG. 1, illustrated is a conventional saw table 10, having a base 12, typically constructed of heavy steel or iron so as to maintain stability allowing for accuracy of saw cuts. The table saw 10 includes an table top 14 having a portion of a rotatable saw blade 16 extending therethrough. The saw blade 16 is typically a ten-inch blade coupled to a motor, not shown, allowing rotation wherein a workpiece is drawn across the upper surface 14 for cutting by the rotating blade 16. An alignment guide or fence 18 is slidable secured along the upper surface 14.

The invention comprises an extension platform 30 that is slidably coupled to the table saw by an aluminum rail 32. The rail 32 fits within a guide 20 found on conventional tables, the guide having a primary function to support the fence 18 used to adjust the distance from the edge of the workpiece to the saw blade. The guide 20 is hollow allowing receipt of the rail 32 which may be moved adjacent to the table top 14. The rail can be made of any length, the preferred embodiment having distance increments of 2 feet, wherein the rail may be 4, 6, 8 or 10 long. The extension platform 30 if formed by a support wall 34 having an adjustable height base 36 with casters 38 and 40. The top of the support wall 34 includes an adjustable material rest 42 having an upper surface 44 that is either coated or constructed of material that provides little or no resistance of work product slid over the material rest. In the preferred embodiment the material rest is made of a soft non-marring plastic.

In operation, the support wall 34 is drawn apart from the table saw to a distance that approximates the width of the workpiece to be modified. The support wall 34 is on caster 38 & 40 allowing ease of movement as the rail 32 is drawn from the guide 20. The rail 32 can be locked in position and a portion of the workpiece placed on the table top 14 and the edge of the workpiece place on the material rest 42. The material rest can be raised or lowered to form a level surface. A single individual can then slide the workpiece along the table top 14 using the fence 18 as a guide to create the desire material cut. As the workpiece is drawn across the table top 14, the adjustable height material rest 42 provides a friction-free surface so as to support the weight of the workpiece during the cutting operation.

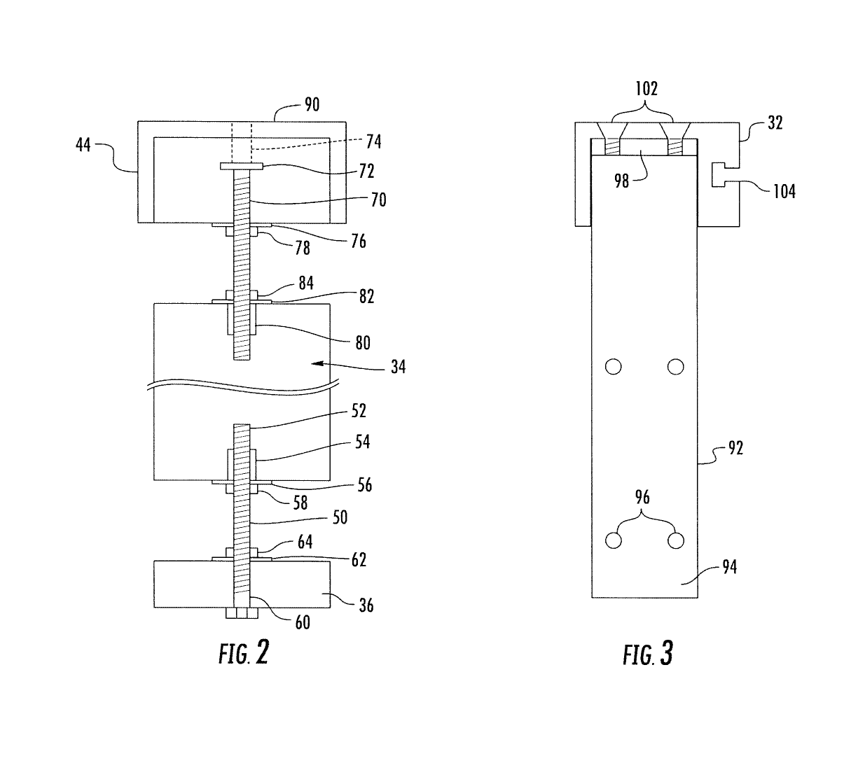

FIG. 2 illustrates the support wall 34, which is coupled to the base 36 by an adjustable bolt 50, having a distal end 52 that extends into the support wall 34, and is supported by a threaded insert 54, with a washer 56 and locknut 58 to maintain the adjustment bolt in position. Similarly, the base 36 has a distal end 60 that extends through the base and is coupled in a fixed position by use of a washer 62 and locknut 64. Casters, shown in FIG. 1, are attached to the base 36. The material rest 42 is secured to the support wall 34 by an adjustment bolt 70, that is adjustable along a proximal end 72 with an aperture 74 placed through the material rest 42, allowing access to the distal end for adjustment. The adjustment bolt 70 employs a washer 76 and locknut 78 so as to maintain the material rest in a fixed position. The adjustment bolt 70 is further attached to the support wall by a threaded insert 80 using a washer 82 and locknut 84 for proper spacing. The material rest 42 includes either a coating or, in a preferred embodiment, a resistant-free material 90, such as a polyurethane or the like plastic covering, to allow a friction-free surface for material to be drawn across.

FIG. 3 illustrates an L-bracket 92 having a lower portion 94 with a plurality of apertures 96 for receipt of fasteners for attaching the L-bracket 92 to the support wall 34. An upper portion 98 of the L-bracket securable to the rail 32 by fasteners 102. The rail 32 including a t-shape groove 104 for receipt of a rail lock for maintaining the position of the rail in respect to the guide.

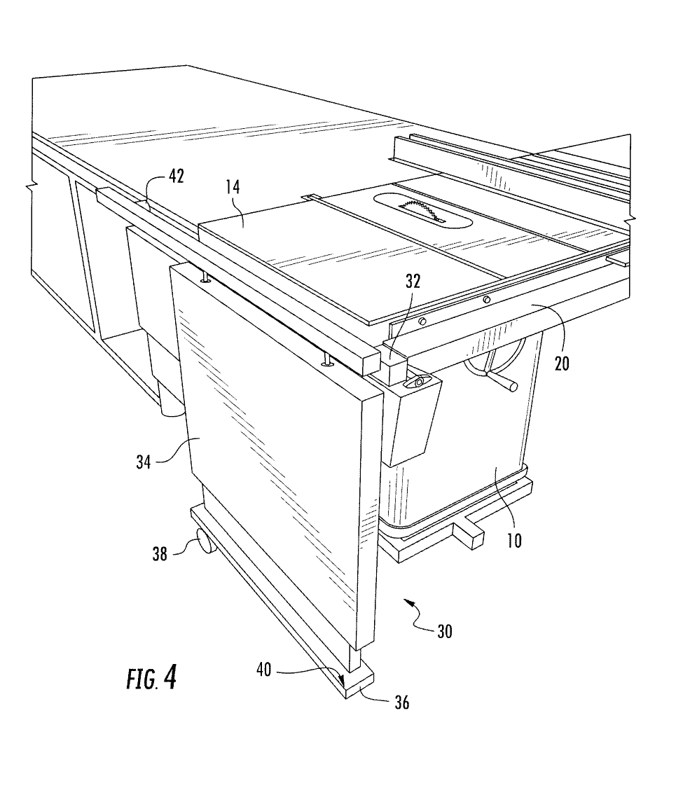

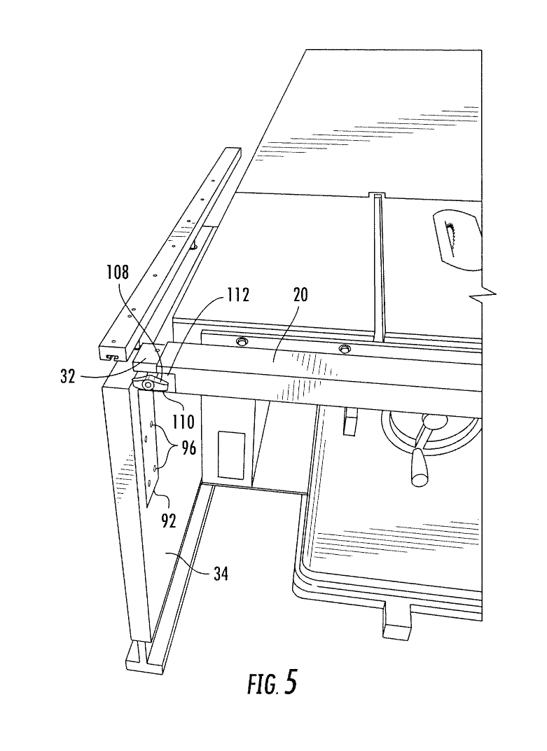

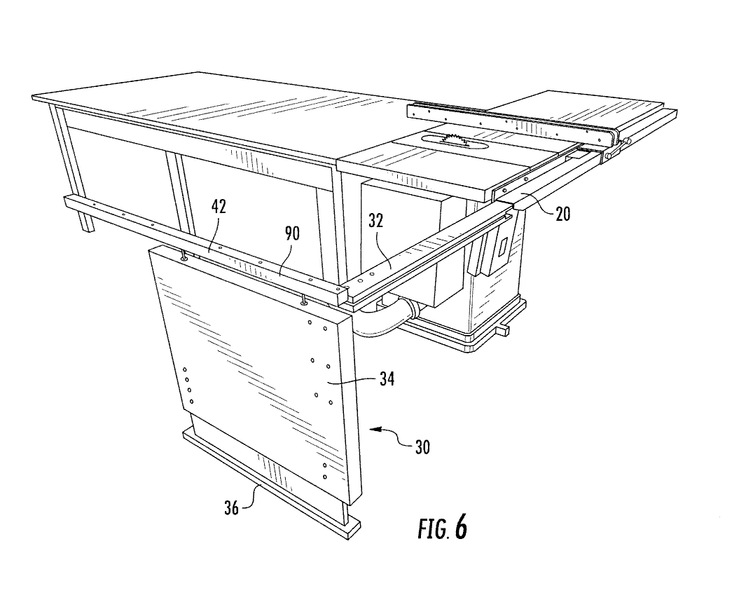

Referring now to FIG. 4, set forth is a pictorial view of a table saw 10, having the extension platform 30 placed in a stored position wherein the rail 32 is completely inserted within the guide 20 and the support wall 34 is adjacent to the table top 14. In this position the table top may be used without removal or displacement of the extension platform. The extension platform 30, having the base 36 with casters 38 and 40 allows ease of placement of the support platform in a storage position. The material rest 42 provides a slight extension to the table top 14, but does not interrupt the use or prevent the operation of the table saw. Now referring to FIG. 5, shown is inner surface of the support wall 34, with the L-bracket 92 fastened to the support wall 34 by fasteners extending through apertures 96. The L-shaped bracket is mounted along an upper portion of the support wall 34 and secured the rail 32 in a perpendicular position. A rail lock 108 which secures the support wall in a fixed position by locking the rail 32 and guide 20 in a fixed position. The rail lock 108 comprises a threaded bolt with a shaped end to engage the T-shaped slot and prevent the bolt from turning. A threaded handle 110 engages the bolt with a washer 112 sized to frictionally engage the outer surface of the rail 32 and guide 20.

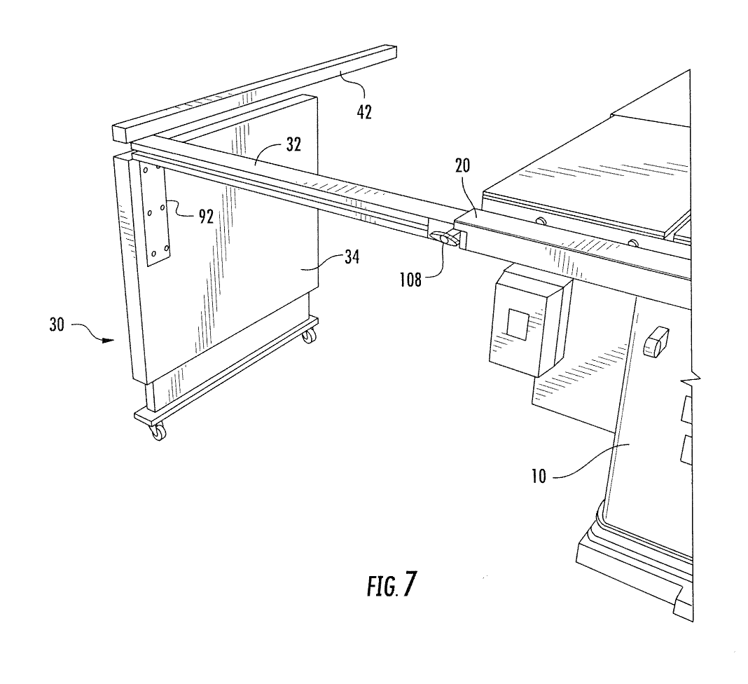

Now referring to FIGS. 6 and 7, the extension platform 30 is depicted in a deployed position, wherein the rail 32 is extended from the guide 20 a distance in accordance with the width of the workpiece to be addressed. The extension platform 30 having the support wall 34 which can be raised or lowered by use of the base 36 and material rest 42. As previously described, the material rest 42 includes a friction resistant-free material 90 such as plastic that encompasses the material rest to prevent marring of the work surface. The support platform 30 as shown in FIG. 7 illustrates the separation of the support wall 34 from the saw table 10 with the L-shaped bracket 92 visible along the inner surface of the support wall and secured to the rail 32 providing an extension in angular positioning of the material rest 42 at a distance from the table top. The locking element 108 is shown securing the rail 32 to the guide 20 so as to prevent movement of the extension platform 30 while a workpiece is being drawn across the material rest and table top.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A table saw extension platform comprising:
a support wall having an upper edge and lower edge, first and second side edges, and first and second side surfaces;
a rail having a length defined by a proximal end and a distal end, said proximal end secured to said first side surface and said distal end constructed and arranged to be held perpendicular to first side surface and slidably inserted into a guide mounted on a table saw; and
a material rest secured to said upper edge of said support wall, said material rest including a surface having a friction reducing material;
wherein said support wall is deployed outwardly from said table saw to a position suitable to support a large workpiece, said material rest allowing ease of movement of the large workpiece in relation to the table saw.

2. The table saw extension platform according to claim 1 including a base element secured to said lower edge of said support wall, said base element including at least one caster for friction reduced movement of said support wall.

3. The table saw extension platform according to claim 2 wherein said base element is adjustably secured to said lower edge of said support wall.

4. The table saw extension platform according to claim 1 wherein said material element is adjustably secured to said upper edge of said support wall.

5. The table saw extension platform according to claim 1 wherein said friction reducing material is plastic.

6. The table saw extension platform according to claim 1 wherein said rail includes a channel for receipt of a locking element, said element constructed and arranged to secure said rail to said guide in a fixed position.

7. The table saw extension platform according to claim 6 wherein said channel is T-shaped.

8. A table saw extension platform comprising:
a support wall having an upper edge and lower edge, first and second side edges, and first and second side surfaces;
a rail having a length defined by a proximal end and a distal end, said proximal end secured to said first side surface and said distal end constructed and arranged to be held perpendicular to first side surface and slidably inserted into a guide mounted on a table saw, said rail includes a channel for receipt of a locking element constructed and arranged to secure said rail to said guide in a fixed position;
a base element secured to said lower edge of said support wall, said base element including at least one caster for friction reduced movement of said support wall; and
a material rest secured to said upper edge of said support wall, said material rest including a surface having a friction reducing material;
wherein said support wall is deployed outwardly from said table saw to a position suitable to support a large workpiece, said material rest allowing ease of movement of the large workpiece in relation to the table saw.

9. The table saw extension platform according to claim 8 wherein said base element is adjustably secured to said lower edge of said support wall.

10. The table saw extension platform according to claim 8 wherein said material element is adjustably secured to said upper edge of said support wall.

11. The table saw extension platform according to claim 8 wherein said friction reducing material is plastic.

12. The table saw extension platform according to claim 8 wherein said channel is T-shaped.
